(19) United States
(12) Patent Application Publication
(10) Pub. No.: US 2026/0016420 A1
(43) Pub. Date: Jan. 15, 2026

(54) DETECTING FOREIGN PARTICLES USING A TDI CAMERA

(71) Applicant: Toyota Research Institute, Inc., Los Altos, CA (US)

(72) Inventor: Matthew P. Gordon, Berkeley, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/330,946

(22) Filed: Sep. 17, 2025

Related U.S. Application Data
(63) Continuation-in-part of application No. 18/115,395, filed on Feb. 28, 2023, now Pat. No. 12,442,746.

(51) Int. Cl. G01N 21/94; G01N 21/88; G01N 21/89; H04N 25/711

(52) U.S. Cl. CPC G01N 21/94; G01N 21/8806; H04N 25/711; G01N 2021/8829; G01N 2021/8841; G01N 2021/8918

(57) ABSTRACT

Various embodiments associated with detecting foreign particles on battery electrodes using a TDI camera are described. In one embodiment, a method includes acquiring an image of an electrode from a time delay integration (TDI) camera. The image is captured by the TDI camera according to a first light source that emits light at a first wavelength and a second light source that emits light at a second wavelength that is different from the first wavelength. The first light source and the second light source are arranged to emit the light onto the electrode from different angles. The electrode is moving between separate rolls. The method includes analyzing the image to detect a particle that is foreign metal contaminating the electrode. The method includes providing an output identifying the particle when detected in the image.

### CROSS-REFERENCE TO RELATED APPLICATIONS

This application is a continuation-in-part of and claims the benefit of U.S. Non-Provisional application Ser. No. 18/115,395, filed on Feb. 28, 2023, which is herein incorporated by reference in its entirety.

### TECHNICAL FIELD

The present disclosure generally relates to metallic particle detection, and particularly to foreign metallic particle detection during roll-to-roll coated electrode manufacturing using a time delay integration (TDI) camera.

### BACKGROUND

Battery production lines may involve calendaring active material onto a strip of metal foil to form anode and cathode electrode strips that may be wound into coils for storage and transport. An electrode strip can be fed into a stacking or winding machine that cuts plate electrodes from the electrode strip, and inserts separator layers between the plate electrodes such that battery cells can be assembled and inserted into battery containers, which are eventually sealed.

The manufacture of plate electrodes and lithium-ion batteries in this manner is an energy and time-efficient process compared to batch processes. However, such electrode manufacturing processes can result in foreign metallic particle contamination of the active material and thus the battery cells. That is, foreign (i.e., unwanted) metallic particles resulting from metal cutting, welding, and/or friction between machine parts can be present on and/or in an active material layer of a plate electrode, and the foreign metallic particles can reduce the performance and operation of a battery cell.

The present disclosure addresses the issue of foreign metallic particle contamination in battery cells, and other issues related to foreign metallic particle contamination.

### SUMMARY

In at least one approach, a scanning system is described. The scanning system includes a camera and a first light source that emits light at a first wavelength and a second light source that emits light at a second wavelength that is different from the first wavelength. The first light source and the second light source are arranged to emit the light onto an electrode from different angles. The electrode is moving between separate rolls. The scanning system includes a controller configured to control the camera to acquire an image of the electrode, and to analyze the image to detect a foreign metallic particle.

In another form, a non-transitory computer-readable medium is disclosed. The non-transitory computer-readable medium stores instructions that, when executed by a processor, cause the processor to acquire an image of an electrode from a time delay integration (TDI) camera, the image being captured by the TDI camera according to a first light source that emits light at a first wavelength and a second light source that emits light at a second wavelength that is different from the first wavelength, wherein the first light source and the second light source are arranged to emit the light onto the electrode from different angles, and wherein the electrode is moving between separate rolls. The instructions include instructions to analyze the image to detect a particle that is foreign metal contaminating the electrode. The instructions include instructions to provide an output identifying the particle when detected in the image.

In still another form, a method is disclosed. The method includes acquiring an image of an electrode from a time delay integration (TDI) camera. The image is captured by the TDI camera according to a first light source that emits light at a first wavelength and a second light source that emits light at a second wavelength that is different from the first wavelength. The first light source and the second light source are arranged to emit the light onto the electrode from different angles. The electrode is moving between separate rolls. The method includes analyzing the image to detect a particle that is foreign metal contaminating the electrode. The method includes providing an output identifying the particle when detected in the image.

These and other features of the fuel cells will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 illustrates a perspective view of an electrode strip production line according to the teachings of the present disclosure;

FIG. 2 is a kymograph showing time (direction of sequential row exposures) versus direction of an electrode strip motion for the exposure of a foreign metallic particle detected on an active material layer and as imaged with a sCMOS camera with a rolling shutter according to the teachings of the present disclosure;

FIG. 3 is a plot of reflectance (%) versus light wavelength reflected from different metals;

FIG. 4A illustrates a foreign metallic particle detector positioned and exposed to a surrounding environment according to the teachings of the present disclosure;

FIG. 4B illustrates a foreign metallic particle detector positioned within an enclosure according to the teachings of the present disclosure;

FIG. 5 illustrates a perspective view of a slitter station according to the teachings of the present disclosure;

FIG. 6A illustrates a perspective view of a cutting station and a stacking station according to the teachings of the present disclosure;

FIG. 6B illustrates a stacked battery cell according to the teachings of the present disclosure;

FIG. 7A illustrates an electrode winding machine for manufacture of a coiled electrode battery cell according to the teachings of the present disclosure;

FIG. 7B illustrates a coiled battery cell according to the teachings of the present disclosure;

FIG. 8 is a block diagram of a foreign metallic detection system according to the teachings of the present disclosure; and

FIG. 9 is a block diagram that illustrates an example of a machine learning system for predicting the presence and/or composition of foreign metallic particles according to the teachings of the present disclosure.

FIG. 10 illustrates one embodiment of a scanning system associated with detecting foreign particles on an electrode using a TDI camera.

FIG. 11 is a diagram illustrating an arrangement of light sources and a TDI camera for capturing images of an electrode.

FIG. 12 is a flowchart illustrating one embodiment of detecting contamination by metal particles on an electrode.

FIG. 13A is a diagram showing forward scattered and back scattered light on a metal particle.

FIG. 13B is a diagram illustrating the scanning pattern of a TDI camera.

It should be noted that the figures set forth herein are intended to exemplify the general characteristics of the methods, algorithms, and devices among those of the present technology, for the purpose of the description of certain aspects. The figures may not precisely reflect the characteristics of any given aspect and are not necessarily intended to define or limit specific forms or variations within the scope of this technology.

### DETAILED DESCRIPTION

Various embodiments are described associated with the detection of contaminating particles on a battery electrode during a manufacturing process. For example, in one or more arrangements, systems and methods perform real-time (i.e., in-situ) detection of foreign metallic particles by leveraging a time delay integration (TDI) camera. That is, the TDI camera images a surface of an electrode as the electrodes moves between rolls. The particular arrangement may include two distinct light sources emitting different wavelengths of light and positioned at different angles relative to the electrode. For example, in one arrangement, a first light source provides red light while the second provides blue light. The TDI camera may have different filters over different regions of an image sensor to separately detect the different light sources.

Moreover, the first and second light sources are positioned in order to provide different types of light scattering. That is, the first light source may be positioned to provide forward scattered light, whereas the second light source may be positioned to provide back scattered light. The TDI camera can capture both of the light sources using separate areas of the image sensor and output an image. An analysis of the image by, for example, a detection model (e.g., a neural network) can function to determine when a particle is present. This may further trigger a subsequent analysis of the image to further classify the particle. In at least one configuration, a scanning system can analyze the image to classify a type of the particle, which may facilitate identifying a source of the particle within a manufacturing facility.

This additional analysis may involve a quasi-3D reconstruction of the particle. This process relies on assessing shadows associated with the forward scattered and back scattered light. Because the angles at which the light sources emit light onto the electrode are known, the scanning system can determine a general geometry (e.g., a height) of the particle based on the shadow length. Because particles of different geometries result from different processes within a manufacturing facility (e.g., cutting, welding splatter, etc.), the likely source of the particle can then be correlated and the source can be mitigated.

In general, the described systems can be used during and/or after a startup period of a new and/or existing plate electrode production line such that enhanced (e.g., faster or quicker) identification of a source or sources of foreign metallic particles is provided. For example, one or more systems can be positioned at different points or locations along a plate electrode production line and used to assist operators in successively narrowing down a likely source of metallic particle contamination by observing which processes or manufacturing steps along the plate electrode production line introduce foreign metallic particles.

In the alternative, or in addition to, portions of an electrode strip contaminated with one or foreign metallic particles can be identified and removed before such portions are assembled into a battery cell unit or a fuel cell unit. For example, in some variations an integrated wireless (e.g., Wi-Fi) or wired network transmits timestamps of detected foreign metallic particles to a controller (e.g., a manufacturing execution system (MES)), which in turn transmits a removal signal to a programmable logic controller (PLC) to trigger automated removal of a contaminated plate electrode and/or a contaminated battery cell or fuel cell from a production line. Accordingly, the system according to the teachings of the present disclosure provides for reduction in downstream labor, materials, and time.

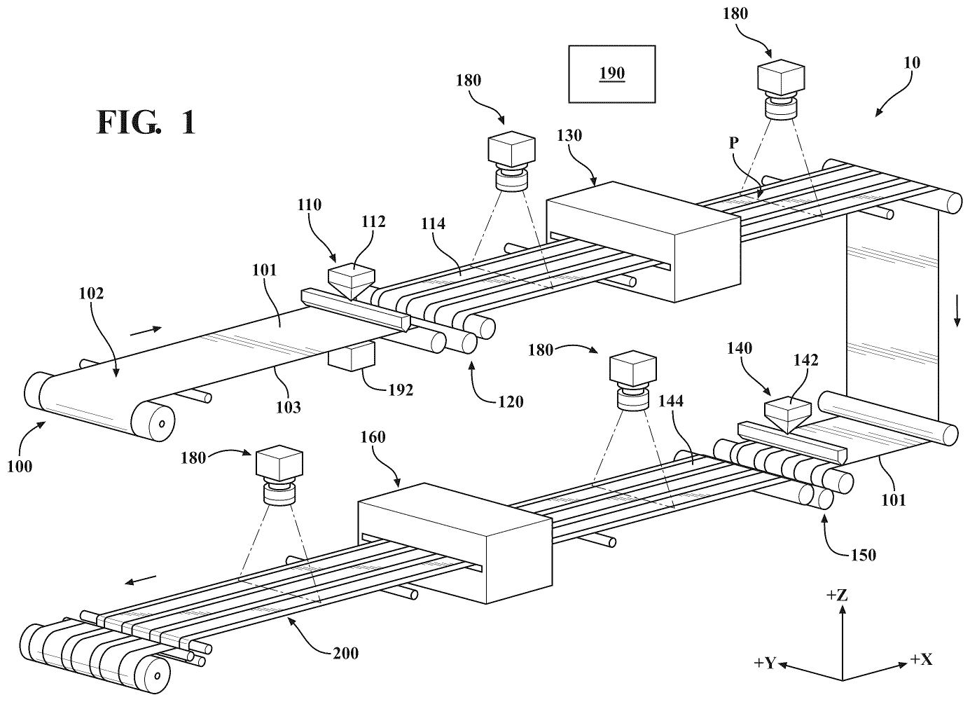

Referring now to FIG. 1, a perspective view of a plate electrode production line 10 (hereafter also referred to simply as “electrode production line 10”) for manufacturing an electrode strip 200 according to the teachings of the present disclosure is shown. The electrode production line 10 includes a source 100 (e.g., a roll) of an charge collector backing layer 102 and an active material source 110 (e.g., a “first active material source 110”) that provides an active material 112 (e.g., a “first active material 112”) onto a first side 101 of the charge collector backing layer 102. In some variations, another active material source 140 (e.g., a “second active material source 140”) that provides another active material 142 (e.g., a “second active material 142”) onto a second side 103 of the electrode backing layer 102 is included. Non-limiting examples of the charge collector backing layer include foil or sheet of copper, aluminum, and alloys thereof.

A set of calendaring rollers 120 and optionally a dryer 130 are included downstream from the first active material source 110, and another set of calendaring rollers 150 and optionally another dryer 160 can be included downstream from the second active material source 142. It should be understood that FIG. 1 represents but one illustrative example of an electrode production line and that additional calendaring rollers, guide rollers, materials sources, and dryers, among other components, can be included in an electrode production line that falls within the scope of the present disclosure.

In some variations, the first active material 112 is the same as the second active material 142 (i.e., has the same chemical composition, particle size(s), etc.), while in other variations the first active material 112 is not the same the second active material 142. Also, in at least one variation the electrode production line 10 is a wet electrode production line such that the first dryer 130 and/or the second dryer 160 are included, while in at least one other variation, the electrode production line 10 is a dry electrode production line such that a free standing electrode film is calendared onto the charge collector backing layer 102 and the first dryer 130 and/or the second dryer 160 are not included. It should be understood that the first active material source 110 is configured to provide or deposit the first active material 112 onto the first side 101 of the charge collector backing layer 102 and form one or more first active material layers 114 thereon and the second active material source 140 is configured to provide or deposit the second active material 142 onto the second side 103 of the charge collector backing layer 102 and form one or more second active material layers 144 thereon. And non-limiting examples of the first active material 112 and/or the second active material 142 include materials containing carbon such that the color of the active material is a dark color. As used herein, the term “dark color” refers to a background that has less than 20% of the reflectance of a foreground object (e.g., a foreign metallic particle) being measured.

Still referring to FIG. 1, the electrode production line 10 includes one or more foreign metallic particle detectors 180. For example, and for illustrative purposes only, a foreign metallic particle detector 180 can be positioned upstream of the first dryer 130, downstream of the first dryer 130, upstream of the second dryer 160, and/or downstream of the second dryer 160. In some variations, a foreign metallic particle detector 180 is moved from one position (e.g., upstream the first dryer 130 and/or the second dryer 160) to another position (e.g., downstream the first dryer 130 and/or the second dryer 160) in order to detect foreign metallic particles on or at least partially within the first active material layer 114 and/or the second active material layer 144 during manufacture of the electrode strip 200. Stated differently, a single foreign metallic particle detector 180 can be releasably attached (e.g., magnetically or mechanically attached to a structural component of the electrode production line 10) at different locations along the electrode production line 10 such that a source of foreign metallic particles can be determined without use or employment of a multi-detector setup or system.

During operation of the electrode production line 10, the first active material source 110 applies the first active material 112 to the first side 101 of the charge collector backing layer 102 to form one or more first active material layers 114 thereon and the one or more first active material layers 114 (i.e., the one or more first active material layers 114 on the charge collector backing layer 102) pass through the first dryer 130 such that solvent within the one or more first active material layers 114 is removed therefrom. It should be understood that the first dryer 130 can be a source or foreign metallic particles, and accordingly, in some variations a foreign metallic particle detector 180 scans the one or more active material layers 114 before entering the first dryer 130 and another foreign metallic particle detector 180 scans the one or more active material layers 114 after passing through the first dryer 130 such that foreign metallic particles can be detected upstream and downstream of the dryer 130 as described in greater detail below.

In variations where the electrode production line includes the second active material source 140, the second active material 142 is applied to the second side 103 of the charge collector backing layer 102 such that one or more second active material layers 144 are formed thereon. Also, the one or more second active material layers 144 pass through the second dryer 160 such that solvent within the one or more second active material layers 144 is removed therefrom. And similar to the first dryer 130, the second dryer 160 can be a source or foreign metallic particles, and accordingly, in some variations a foreign metallic particle detectors 180 scans the one or more active material layers 144 before entering the second dryer 160 and another foreign metallic particle detector 180 scans the one or more active material layers 144 after passing through the second dryer 160. And while FIG. 1 illustrates foreign metallic particle detectors 180 upstream and downstream of the first and second dryers 130, 160, it should be understood that one or more foreign metallic particle detectors 180 can be positioned upstream and/or downstream other components or stations along the electrode production line 10 including but not limited to coating components/stations, pressing components/stations, slitting components/stations, notching components/stations, stacking components/stations, welding components/stations, assembly components/stations, and scaling components/stations, among others.

Not being bound by theory, the presence of a foreign metallic particle on or partially within the one or more active material layers 114 and/or second active material layers 144 reflects more incident light than the surrounding active material 112, 142. For example, metallic particles with an average size or diameter greater than about 10 micrometers (μm) strongly reflect light under desired illumination conditions. Accordingly, the difference between the low reflection of light (e.g., less than 10%) by the active material 112, 142 and the high reflection of light (e.g., greater than 50%) by a metallic particle is imaged by a foreign metallic particle detector 180 such that the presence of a foreign metallic particle is detected.

As used herein, the term “light” refers to ultraviolet (UV) light, visible light, and/or infrared (IR) light. For example, in some variations, foreign metallic particles are detected via illumination of the first active material layer 114 and/or the second active material layer 144 with UV light, while in other variations foreign metallic particles are detected via illumination of the first active material layer 114 and/or the second active material layer 144 with visible light. In at least one variation, foreign metallic particles are detected via illumination of the first active material layer 114 and/or the second active material layer 144 with IR light. And in some variations, foreign metallic particles are detected via illumination of the first active material layer 114 and/or the second active material layer 144 with a combination of UV, visible and/or IR light.

Still referring to FIG. 1, in some variations, the one or more foreign metallic particle detectors 180 are in communication (e.g., wired and/or wireless communication) with a controller 190 such that a timestamp of a detected foreign metallic particle ‘P’ in combination with an encoder 192 in-situ identifies and stores a physical position (location) of the detected foreign metallic particle P on the electrode strip 200. And in such variations a section of the electrode strip 200 containing or having the foreign metallic particle P can be identified and removed before the section is placed within a battery cell or a fuel cell.

In some variations, one or more of the foreign metallic particle detectors 180 is a line scan camera 180. For example, a foreign metallic particle detector 180 can have a line scan sensor with between 512 to 12,000 (12 k) pixels (e.g., 512, 1 k, 2 k, 4 k, 8 k, 12 k, among others) that may or may not be read out on multiple channels (e.g., dual channels, quad channels, eight channels, among others). In addition, the pixels can have a size of about 5 μm×5 μm, 7 μm×7 μm, 10 μm×10 μm, 14 μm×14 μm, among others. The magnification of the line scan camera can be adjusted such that reflection from a foreign metallic particle P having an average diameter less than a predetermined size (e.g., ≤100 μm) is captured within a single pixel (e.g., a 20:1 magnification to image a 100 μm particle within a 5 μm×5 μm pixel). And in such variations, an image of the foreign metallic particle P contributes most if not all of the signal to a single pixel and thereby maximizes the relative contribution of the foreign metallic particle P and the substrate (i.e., surrounding active material layer 114) to an image of the foreign metallic particle P.

In other variations, one or more of the foreign metallic particle detectors 180 is an area scan camera 180. For example, the area scan camera 180 can be a sCMOS camera with a rolling shutter. In addition, the magnification of the sCMOS camera can be adjusted such that reflection from a foreign metallic particle P having an average diameter less than a predetermined size (e.g., ≤100 μm) is captured within a minimum of a single pixel (e.g., 3 to 5 pixels) of the SCMOS camera (e.g., a 20:1 magnification to image a 100 μm particle within a 5 μm×5 μm pixel). And in such variations, an image of the foreign metallic particle P contributes most if not all of the signal to a single pixel and thereby maximizes the relative contribution of the foreign metallic particle P and the substrate (i.e., surrounding active material layer 114) to an image of the foreign metallic particle P.

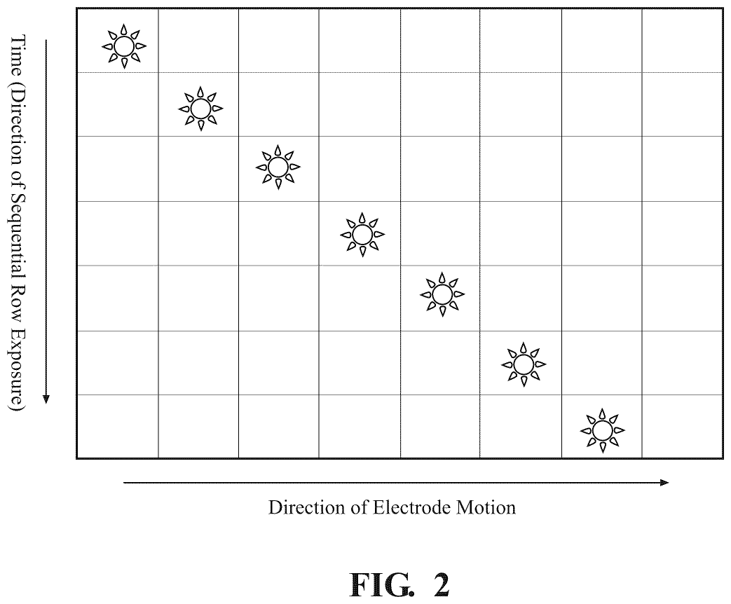

The rolling shutter exposes each camera row in sequence such that a sequence of individual scans can be provided. In addition readout times as fast as 10 microseconds (usec) per row can be provided and such readout times allow for ‘N’ independent measurements of a single metal particle such that confidence of a single particle detection is enhanced. For example, and with reference to FIG. 2, a kymograph of a single metallic particle can be provided such that an image of the single metallic particle appears as a line, instead of a single point, when rows of the rolling shutter are assembled. Accordingly, use of such an area scan camera 180 provides enhanced detection of foreign metallic particles P with lower signal to noise ratios.

In some variations, the shutter time and magnification can be set or adjusted such that each exposure results in a particle moving about 1 one row (i.e., about 50 usec) and the benefits of maximal signal to noise ratio exposure is obtained. Also, about 1000 measurements per particle can be obtained. And assuming 1 watt of illumination on a 10 cm×10 cm patch of electrode, a single 100 μm particle induces about 200,000 photons per pixel in 50 μsec such that with an assumed 50% quantum efficiency, signals for detection of foreign metallic particles using the area scan camera 180 provide sufficient imaging thereof.

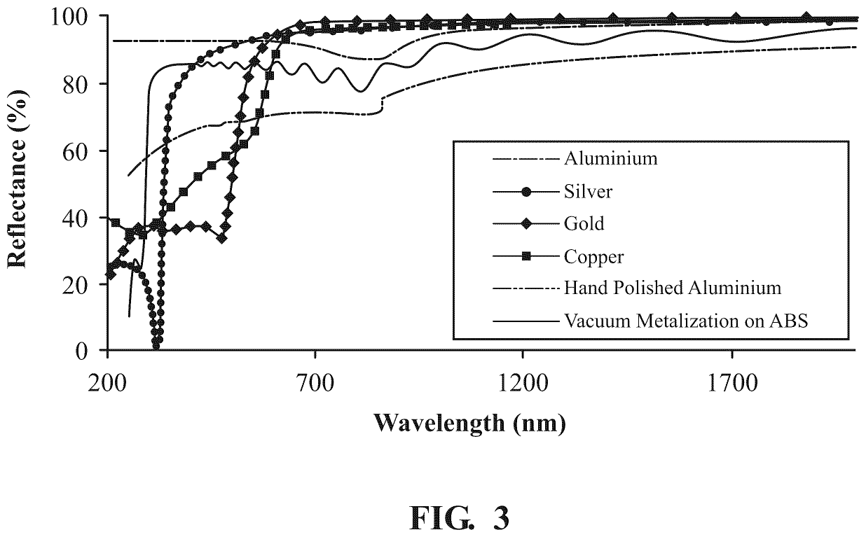

Referring now to FIG. 3, in some variations the one or more foreign metallic particle detectors 180 and/or the controller 190 provide a chemical characterization of a foreign metallic particle. For example, metals such as aluminum, silver, gold, and copper, among others, exhibit a signature reflectance versus light wavelength profile. Accordingly, detecting and measuring the percentage (%) of light reflected from a metallic particle as a function of incident light wavelength is used to chemically characterize and detect foreign metallic particles. For example, and assuming an average 10% background noise from an active material layer, an aluminum particle would exhibit a signal to noise ratio between about 9.0 and about 9.5 for incident light having wavelengths between about 200 nm and about 500 nm, whereas a copper particle would exhibit a signal to noise ratio between about 3.0 and about 4.0 for incident light having wavelengths between about 200 nm and about 500 nm. Accordingly, the foreign metallic particle detector 180 and/or the controller 190 distinguishes between a foreign aluminum particle and a foreign copper particle (and other foreign metallic particles) using a lookup table of signal-to-noise ratios for different metallic particles. It should be understood that other techniques and components (e.g., dichroic filters) can be used to identify and chemically characterize foreign metallic particles according to the teachings of the present disclosure. For example, in some variations multi-band spectroscopy is used in which a dichroic filter splits light scattered from a foreign metallic particle into two or more channels, and a differential measurement of the light intensity in each channel to determine of a chemical characterization of a foreign metallic particle. In other variations, an optical spectrometer with a diffraction grating and a 2D sensor are used to provide hyperspectral imaging to determine a chemical characterization of a foreign metallic particle.

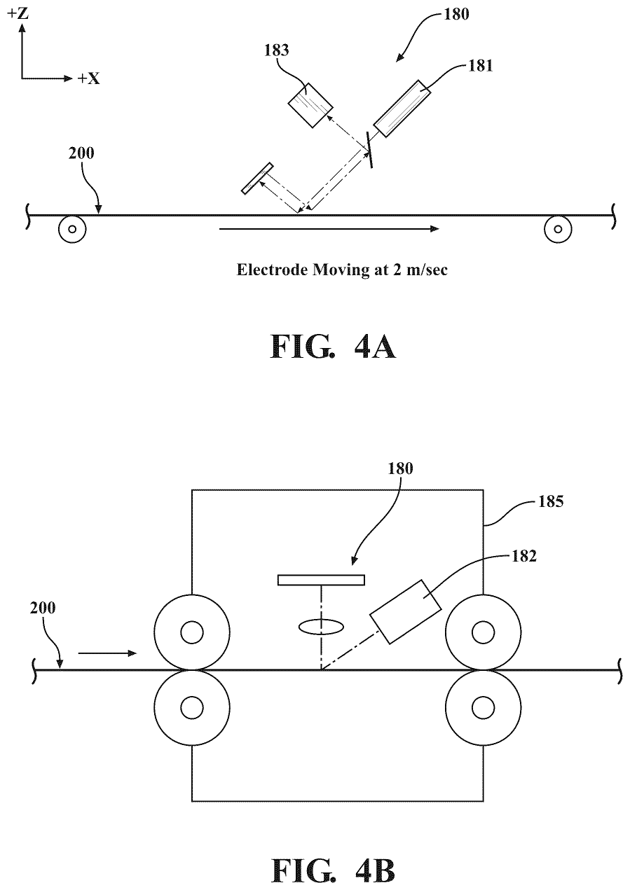

Referring to FIGS. 4A-4B, in some variations the one or more foreign metallic particle detectors 180 are exposed to a surrounding production line environment (i.e., not contained with an enclosure) as illustrated in FIG. 4A, while in other variations the one or more foreign metallic particle detectors 180 are positioned or contained with a light-tight enclosure 185 (also referred to herein simply as “enclosure”) as illustrated in FIG. 4B. For example, and with reference to FIG. 4A, use of an UV or IR light source 181 for propagating UV or IR light onto the active material layer 114 results in ambient or factory light not being detected by or interfering with UV or IR light reflected from a foreign metallic particle and detected or image by a camera 132. Accordingly, protecting or shielding the foreign metallic particle detector 180 from “outside” light is not employed. In the alternative, the enclosure 185 (FIG. 4B) shields the one or more foreign metallic particle detectors 180 from ambient or factory light such that a UV or IR light is not required, a visible light source 182 (e.g., a broadband light source or a visible laser light source) can be used, and/or an increase in the signal to noise ratio of light reflected from foreign metallic particles illuminated within the enclosure 185 is provided. And while FIGS. 4A-4B show only one foreign metallic particle detector 180 exposed to a surrounding environment and only one foreign metallic particle detector 180 positioned within an enclosure, respectively, it should be understood that the electrode production line 10 can include one or more foreign metallic particle detectors 180 exposed to a surrounding environment (i.e., not within an enclosure) and one or more foreign metallic particle detectors 180 positioned or contained within the enclosure 185. In addition, in some variations one or more of the foreign metallic detectors 180 include more than one type of detector (e.g., a line scan camera and a multi-band spectroscopy system, a dark field camera/imager and a bright field camera/imager, among others) and/or more than one imaging modality (e.g., simultaneous bright field and dark field spectroscopy imaging).

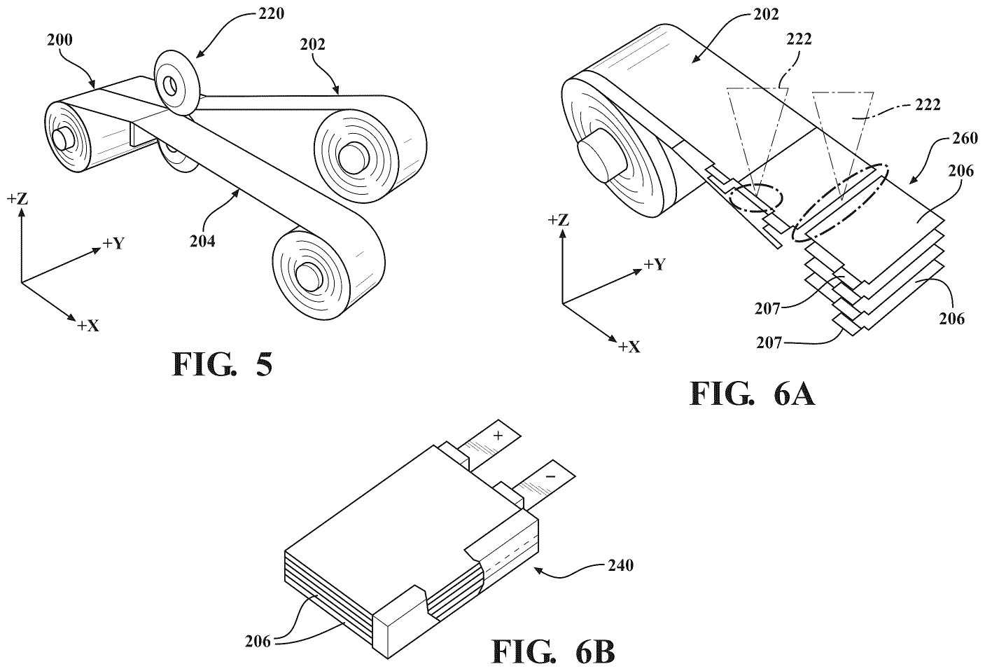

Referring now to FIG. 5, in some variations the electrode production line 10 includes a slitter 220 (e.g., a mechanical or laser slitter) that cuts the electrode strip 10 in a length direction such that at least two electrode strips 202, 204 are formed for further processing. Also, in at least one variation one or both of the electrode strips 202, 204 (referred to hereafter simply as “electrode strip 202”) is cut into panels 206 with tabs 207 using one or more cutters 222 (e.g., a laser cutter) as illustrated in FIG. 6A and the panels 206 are assembled with separator layers (not shown) at a stacking station 260 to form battery cells 240 illustrated in FIG. 6B. It should be understood that the slitter 220 and/or the one or more cutters 222 can be a source of foreign metallic particles, and thus, while not shown in FIGS. 5 and 6A, one or more foreign metallic particle detectors 180 can be positioned upstream and/or downstream of the slitter 220 and/or the one or more cutters 222.

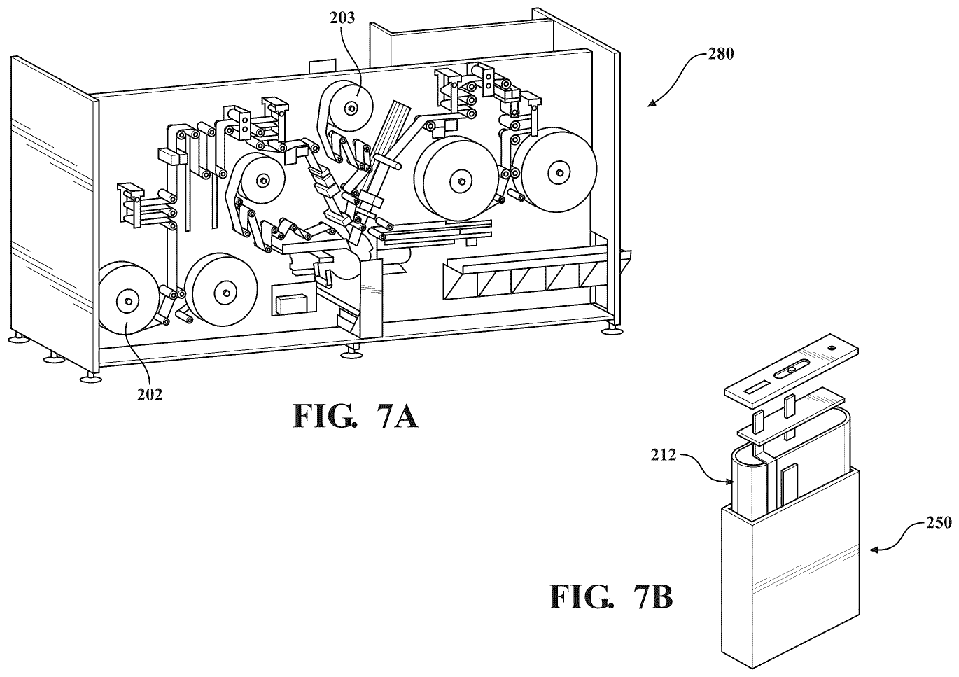

Referring to FIGS. 7A-7B, in at least one variation, an electrode winder 280 winds an electrode strip 202 (or 204) with a separator layer 203 to form coil electrode cells 212 (also known as “jelly rolls”) for coil batteries 250. And while a foreign metallic particle detector 180 is not shown in FIG. 7A, it should be understood that one or more foreign metallic particle detectors 180 can be positioned along the processing route of the electrode strip 202 within the electrode winder 280 for detecting foreign metallic particles and a source of foreign metallic particles.

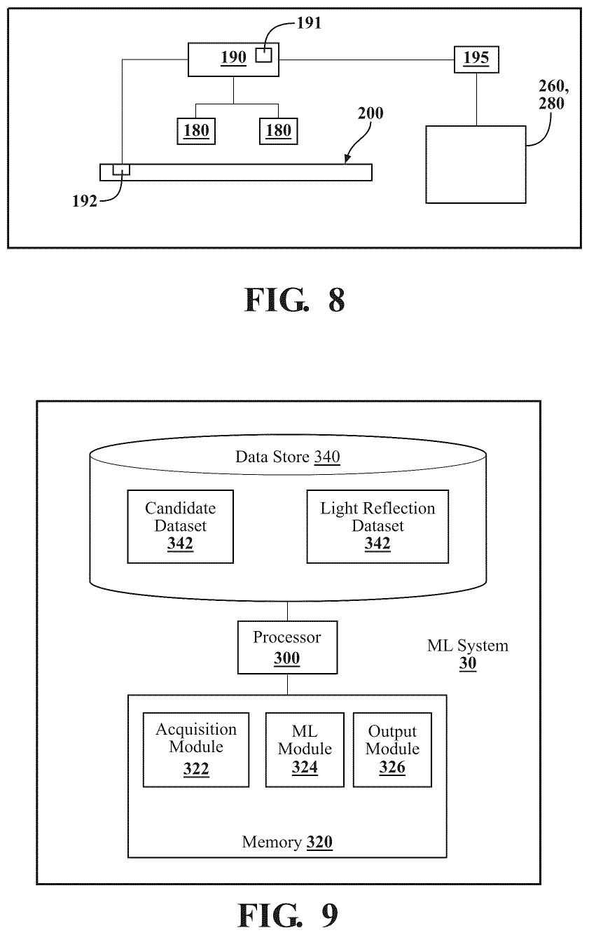

Referring to FIG. 8, a block diagram for the electrode production line 10 is shown. The electrode production line 10 includes the one or more foreign metallic particle detectors 180 and the encoder 192 in communication with the controller 190 such that the presence of one or more foreign metallic particles P can be detected and its position or location on the electrode strip 200 determined and stored in a memory 191. In some variations, the controller 190 is configured to receive signals provided from the detector 180 and determine foreign metallic particles P with an average diameter greater than or equal to about 10 μm and less than or equal to 1500 μm, for example, an average diameter between about 25 μm and 1000 μm, between about 25 μm and about 500 μm, or between about 25 μm and about 250 μm.

The electrode production line 10 can include the stacking station 260 and/or the electrode winder 280, and a programmable logic controller 195 in communication with the controller 190 can execute a command to remove one or more of the panels 206 or jelly rolls 208 that the controller 190 and/or the one or more foreign metallic particle detectors 180 has identified as containing one or more foreign metallic particles P. In the alternative, or in addition to, the programmable logic controller 195 can be in communication with the controller 190 and can execute a command to remove an electrode cell 210, 212 that has been identified as containing one or more foreign metallic particles.

Referring to FIG. 9, in some variations, the controller 190, or another controller (not shown) in communication with the controller 190, includes a machine learning (ML) system 30 configured to learn and identify foreign metallic particles. The ML system 30 is shown including one or more processors 300 (referred to herein simply as “processor 300”), a memory 320 and a data store 340 communicably coupled to the processor 300. It should be understood that the processor 300 can be part of the ML system 30, or in the alternative, the ML system 30 can access the processor 100 through a data bus or another communication path.

The memory 320 is configured to store an acquisition module 322, an ML module 324, and, in some variations, an output module 326. The memory 320 is a random-access memory (RAM), read-only memory (ROM), a hard-disk drive, a flash memory, or other suitable memory for storing the acquisition module 322, the ML module 324, and the output module 326. Also, the acquisition module 322, ML module 324, and output module 326 are, for example, computer-readable instructions that, when executed by the processor 300, cause the processor(s) to perform the various functions disclosed herein.

In some variations, the data store 340 is a database, e.g., an electronic data structure stored in the memory 320 or another data store. Also, in at least one variation the data store 340 in the form of a database is configured with routines that can be executed by the processor 300 for analyzing stored data, providing stored data, organizing stored data, and the like. Accordingly, in some variations the data store 340 stores data used by one or more of the acquisition module 322, ML module 324 and output module 326. For example, and as shown in FIG. 9, in at least one variation the data store 340 stores a candidate dataset 342 and a light reflection dataset 344. In some variations, the candidate dataset 342 includes a listing of a plurality of metallic particles, including a listing of particle sizes and particle chemical compositions. Also, the light reflection dataset 344 includes percent light reflected as a function of light wavelength, and optionally as a function of particle size, for one or more of the plurality of metallic particles listed in the candidate dataset 342. And in at least one variation, the candidate dataset 342 includes a training dataset with one or more metallic particles tagged with one or more percent light reflected as a function of light wavelength.

The acquisition module 322 can include instructions that function to control the processor 300 to select a metallic particle from the candidate dataset 342 and a corresponding percent reflected light as a function of light wavelength from the light reflection dataset 344. And in at least one variation, the acquisition module 322 can include instructions that function to control the processor 300 to provide the selected metallic particle and the corresponding percent reflect light as a function of light wavelength as an input dataset to the ML module 324.

The ML module 324 includes instructions that function to control the processor 300 to train an ML model (algorithm) using the input dataset. In some variations, the ML module 324 includes instructions that function to control the processor 100 to train the ML model unsupervised. In other variations, the ML module 324 includes instructions that function to control the processor 300 to train the ML model supervised using a training dataset with one or more metallic particles with one or more percent reflected light as a function of wavelength. Stated differently, in some variations the input dataset can include one or metallic particles tagged with one or more percent reflected light as a function of light wavelength (e.g., a training dataset) and the ML module 324 trains the ML model to predict the tagged percent reflected light as a function of light wavelength for the one or more metallic particles to within a desired value (i.e., less than or equal to a desired value) of a cost function (also known as a “loss function”). In other variations, the input dataset can include images of foreign metallic particles with or without data on overall light intensity, shape, and position of electrode, among others, and the ML module 324 trains the ML model to predict if a foreign metallic particle is present based on a captured image. And after training of the ML model, the ML module 324 includes instructions that function to control the processor 300 to predict metallic particles, both size and chemical composition, for metallic particles not tagged with the percent reflected light as a function of light wavelength (i.e., not in the training dataset).

Non-limiting examples of the ML model include ML models such as nearest neighbor models, Naïve Bayes models, linear regression models, support vector machine (SVM) models, and neural network models (e.g., convolutional neural networks, visual large language models (VLM)), among others. And, in at least one variation, the ML model is a Gaussian Process regression model. Also, training of the ML model provides a model that predicts an optimized material composition with respect to a predefined material property to within a desired value (i.e., less than or equal to a desired value) of a cost function (also known as a loss function).

In operation of one embodiment, the ML system 30 learns the percentage of light reflected from foreign metallic particles having different sizes and/or chemical compositions. In some variations, the ML system 30 learns the percentage of light reflected, overall light intensity, shape, and/or among other characteristics from foreign metallic particles having different sizes and/or chemical compositions of foreign metallic particles as a function of light wavelength, multi-channel light intensity differential measurements, and/or hyperspectral imaging. In addition, the ML system 30 receives signals from the one or more foreign metallic particle detectors 180 and identifies foreign metallic particles, foreign metallic particles sizes, and/or foreign metallic particle chemical composition based on the received signals. The ML system 30 may further be implemented to visually detect the presence of a particle according to patterns within an image acquired via a TDI camera where the image includes one or more light sources providing different scattering patterns. In yet further arrangements, the ML system 30 may further identify a geometry of the particle to facilitate classifying the particle. In this way, the ML system 30 can improve the detection and classification of foreign metallic particles.

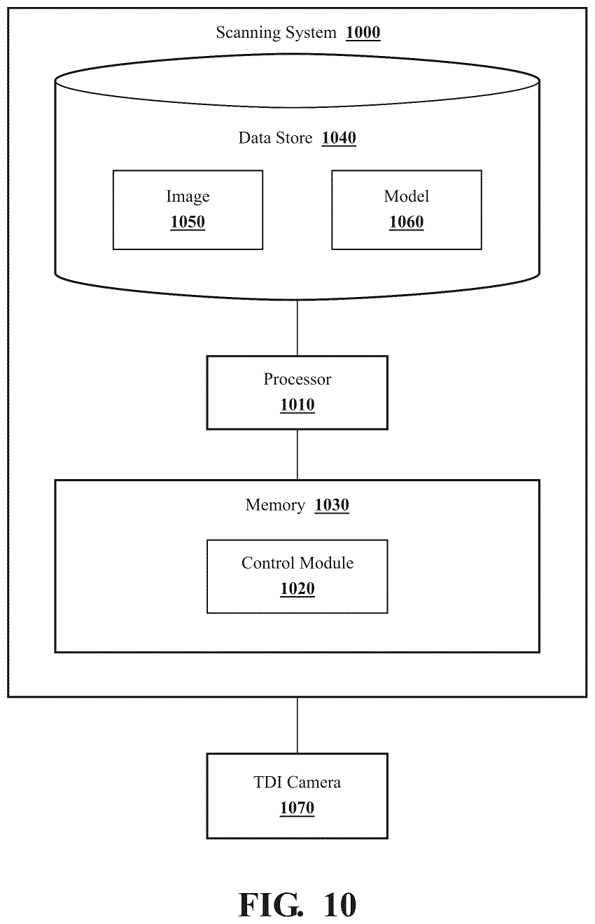

With reference to FIG. 10, one example of a scanning system 1000 that detects particles on an electrode using a TDI camera is shown. While depicted as a standalone component, in one or more embodiments, the scanning system 1000 is cloud-based and thus can include elements that are distributed among different locations. In general, the scanning system 1000 is implemented to detect contamination in the form of the metal particles, which may result from various manufacturing processes within a facility. The noted functions and methods will become more apparent with further discussion of the figures.

With further reference to FIG. 10, one embodiment of the scanning system 1000 is further illustrated. The scanning system 1000 is shown as including a processor 1010. Accordingly, the processor 1010 may be a part of the scanning system 1000, or the scanning system 1000 may access the processor 110 through a data bus or another communication path. In one or more embodiments, the processor 110 is an application-specific integrated circuit (ASIC) that is configured to implement functions associated with a control module 1020. For example, the ASIC may be embodied as a hardware-based controller that is situated with a camera (e.g., TDI camera 1070) proximate to a manufacturing line for batteries. In general, the processor 110 is an electronic processor, such as a microprocessor, that is capable of performing various functions as described herein. In one embodiment, the scanning system 1000 includes a memory 1030 that stores the control module 1020 and/or other modules that may function in support of detecting the particles. The memory 1030 is a random-access memory (RAM), read-only memory (ROM), a hard disk drive, a flash memory, or other suitable memory for storing the control module 120. The control module 120 is, for example, computer-readable instructions that, when executed by the processor 110, cause the processor 110 to perform the various functions disclosed herein. In further arrangements, the control module 120 is a logic, integrated circuit, or another device for performing the noted functions that includes the instructions integrated therein.

Furthermore, in one embodiment, the scanning system 1000 includes a data store 1040. The data store 1040 is, in one arrangement, an electronic data structure stored in the memory 1030 or another electronic medium, and that is configured with routines that can be executed by the processor 1010 for analyzing stored data, providing stored data, organizing stored data, and so on. Thus, in one embodiment, the data store 1040 stores data used by the control module 1020 in executing various functions. For example, as depicted in FIG. 1, the data store 1040 includes the image 1050, and a model 1060 that are, in at least one approach, machine-learning models along with, for example, other information that is used and/or produced by the control module 1020. While the scanning system 1000 is illustrated as including the various elements, it should be appreciated that one or more of the illustrated elements may not be included within the data store 1040 in various implementations. In any case, the scanning system 1000 stores various data elements in the data store 1040 to support functions of the control module 1020.

Moreover, as illustrated, the scanning system 1000 is operably connected with a TDI camera 1070. That is, the scanning system 1000 maintains a connection with the TDI camera 1070 in order to, in at least one arrangement, control the TDI camera 1070 and send and receive information between the camera 1070 and the control module 1020. Thus, the connection between the TDI camera 1070 and the scanning system 1000 may take different forms, such as a wireless connection (e.g., WiFi) or a wired connection (E.g., Ethernet). In general, the TDI camera 1070 operates by iteratively imaging the electrode as the electrode moves between separate rolls. The electrode may move at a relatively quick speed (e.g., 2 m/s) as it transfers from a first roll to a second a roll. The TDI camera 1070 is, in general, a type of line-scan camera that synchronizes the capture of lines of pixels with the movement of the electrode.

In general, an image sensor within the TDI camera 1070 has rows of pixels, which may be referred to as stages. As the electrode moves past the TDI camera 1070, a first row of pixels captures an area of the electrode corresponding to the pixels. The TDI camera 1070 transfers the charged captured in the pixels of the image sensor for the first row to a subsequent row of pixels in the image sensor at a substantially same time as the subsequent row of pixels captures the same area of the electrode, while the first row captures a subsequent area of the electrode. This process of charge transfer and integration is repeated across the rows of pixels in the image sensor of the TDI camera 1070 such that the same area of the electrode is imaged iteratively by the rows of pixels in the TDI camera 1070. As a result, the generated image has an improved signal-to-noise ratio resulting in clearer images.

The image sensor within the TDI camera 1070 may be a charge-coupled device (CCD) or a specialized complimentary metal-oxide semiconductor (CMOS) sensor. Moreover, the rows of pixels in the image sensor may include separate color filters associated with light sources used to light the electrode. That is, for example, in various configurations, a portion of the rows of pixels may have a first color filter (e.g., red) while a second portion of the rows of pixels have a second color filter (e.g., blue). The light sources correspond with the color filters such that the separate rows of pixels focus imaging the corresponding areas of the electrode.

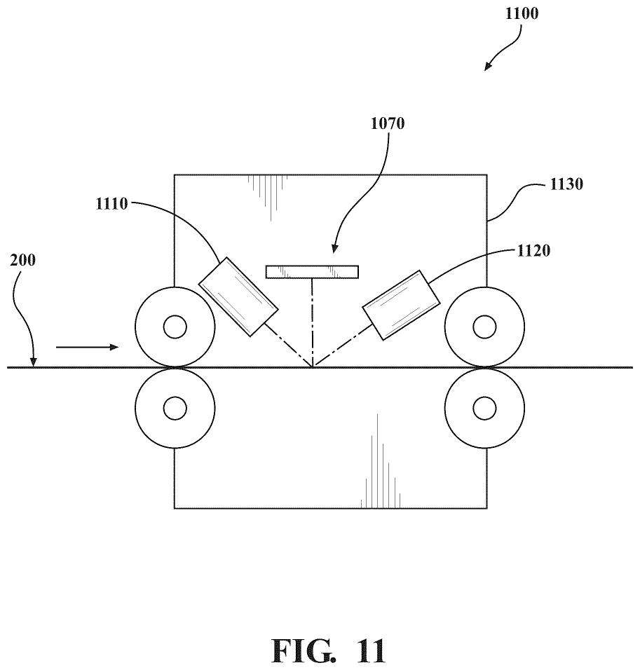

As one example of an arrangement of the TDI camera 1070 and the light sources relative to the electrode, consider FIG. 11. FIG. 11 illustrates a portion of a manufacturing line 1100 for inspecting the electrode 200. In the illustrated configuration, the TDI camera 1070 is located directly above an area being imaged while a first light source 1110 and a second light source 1120 are located at different angles relative to the electrode 200 in order to produce forward scattered and back scattered light, respectively, and are mounted within a housing 1130 that prevents ambient light from influencing the imaging. That is, the light sources 1110 and 1120 are intentionally placed at different angles in order to cause any particles present on the electrode to cast a shadow within the light from the respective light sources. Moreover, the light sources 1110 and 1120 emit different wavelengths of light that correspond with the color filters of the image sensor such that the associated separate areas of the image sensor focus imaging on areas illuminated with the respective wavelengths of light.

With continued reference to FIG. 10 and the elements of the data store 1040, the image 1050 is produced from the TDI camera 1070 imaging the electrode 200 using the light sources 1110/1120. It should be appreciated that the precise dimensions of the image 1050 may vary depending on the implementation. That is, the width of the image 1050 is generally the same as the width of the electrode 200 and the image 1050 may further include separate channels for the colors associated with the light sources. The length of the image 1050 is generally not constrained by the TDI camera 1070 itself as the TDI camera 1070 can generate a continuous stream associated with the moving electrode. However, for practical purposes, in at least one arrangement, the image 1050 is defined along a length dimension according to a dimension that the model 1060 can accept as input. Thus, an input tensor for the model 1060 may have dimensions of 299×299×2. Of course, different dimensions (e.g., 5 micron pixels at 163 wide by 299 long×2 channels) are possible for the image 1050 and, thus, the input to the model 1060. Moreover, because of the continuous nature of the electrode 200, the image may include a defined number of pixels that overlap with each image to ensure areas are not split between two images.

In any case, the model 1060 is, in one arrangement, a convolutional neural network or another machine learning algorithm that can process visual data to detect particles. For example, the model 1060 may be trained on a dataset of previously labeled images where the particles are labeled. In a further arrangement, the labels may further indicate a type of the particle (e.g., a general geometry, such as flat, round, etc.). The model 1050 can then be trained to at least detect the particles and may be further trained to classify the particles.

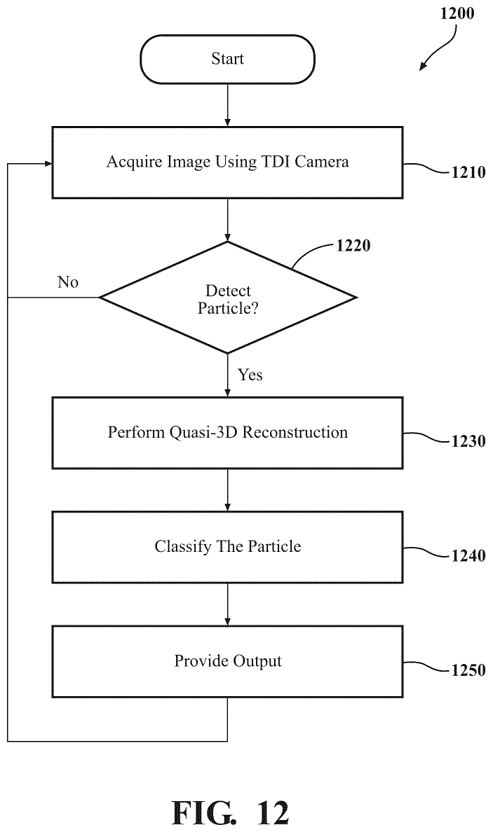

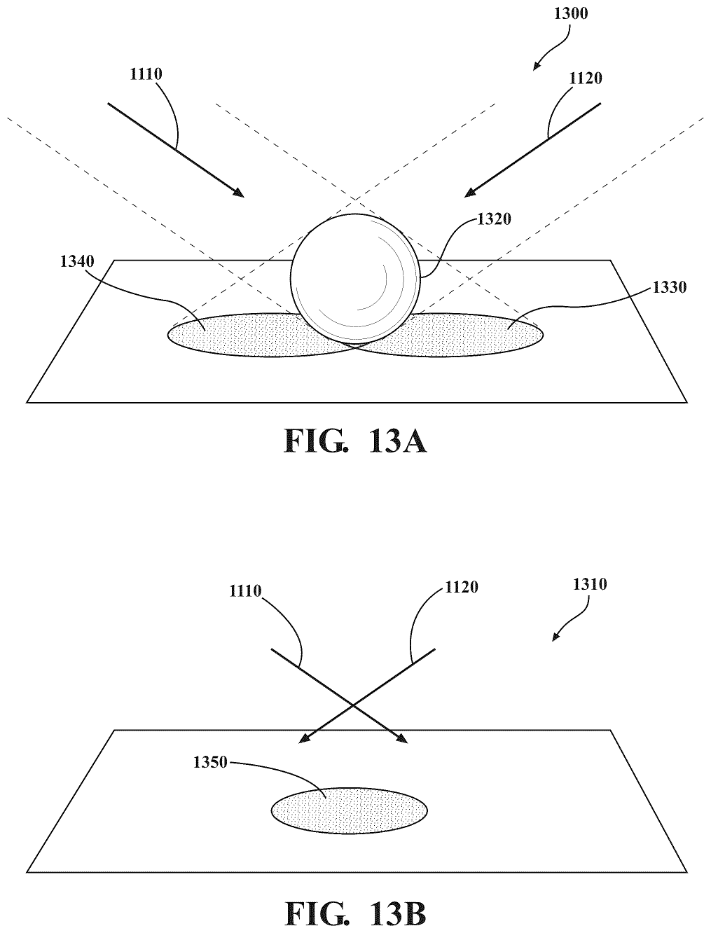

Additional aspects of detecting particles using a TDI camera will be discussed in relation to FIGS. 12-13. FIG. 12 illustrates a flowchart of a method 1200 that is associated with detecting metallic contamination on an electrode. Method 1200 will be discussed from the perspective of the scanning system 1000 of FIG. 10. While method 1200 is discussed in combination with the scanning system 1000, it should be appreciated that the method 1200 is not limited to being implemented within the scanning system 1000 but is instead one example of a system that may implement the method 1200.

At 1210, the control module 1020 acquires the image 1050 from the TDI camera 1070. As indicated previously, the configuration of the TDI camera 1070 and the light sources 1110 and 1120 is specific to the present approach in order to facilitate imaging the electrode 200 in a particular way that acquires both front scattered and back scattered light. As noted, the light sources provide light in the range of 650 nm to 1000 nm and 375 to 475 nm with filters in the TDI camera 1070 being correlated with these wavelengths of light.

The TDI camera 1070 iteratively acquires individual lines of pixels and transfer the lines to subsequent lines of pixels with different sets of the lines of pixels being filtered according to the separate wavelengths. Thus, the resulting image 1050 generally has two separate areas that are separately associated with front scattered and backscattered light per the associated wavelengths of light. This permits the scanning system 1000 to assess any particles that are present on the electrode 200 from two separate perspectives. As one example, consider FIGS. 13A and 13B, which illustrate a first scenario 1300 and a second scenario 1310, respectively. In the first scenario 1300, a metallic particle 1320 is shown with two separate shadows 1330 and 1340 from the separate light sources 1110 and 1120, as illustrated by the arrows depicting the direction of the light from these sources. In the scenario 1310, a metallic particle 1350 is shown. The particle 1350 has a geometry that is generally flat, which is why there is no associated shadows, whereas the particle 1320 is more spherical, and thus casts the shown shadows 1330 and 1340. Accordingly, the associated images derived by the TDI camera 1070 depict these disparities according to the geometries, which will be discussed further subsequently.

At 1220, the control module 1020 detects whether the image 1050 includes a particle or not. In at least one arrangement, the control module 120 analyzes the image 1050 to detect a particle having a diameter of about 25 μm to about 1000 μm. The control module 1020 may implement various approaches to analyze the image 1050. The control module 1020 may apply a machine learning model (e.g., a convolutional neural network (CNN)) to the image 1050 to detect the particle, an algorithm that detects variations in pixel intensities and/or colors, or another approach. In any case, when the control module 1020 detects a particle, the scanning system 1000 may then proceed with performing additional analysis as described at block 1230. Otherwise, the scanning system 1000 proceeds back to iteratively acquiring and analyzing images. It should be noted that while the process is shown in a serial manner, various elements may occur in parallel, such as the acquisition of the image 1050.

At 1230, the control module 1020 performs a quasi-3D reconstruction of the detected particle. For example, in at least one arrangement, the control module 1020 determines a length of any shadows cast by the particle. That is, the control module 1020 can distinguish between the shadow of the first light source and the second light source and also is programmed with the information about the angle of the light sources relative to the electrode. Therefore, the control module 1020 can use the length of the shadows to determine a height of the particle, thereby providing a rough estimate of the overall geometry. In one arrangement, the control module 1020 can estimate the height along multiple axes through the particle in order to provide a more accurate assessment of the geometry, instead of at just a single axis.

At 1240, the control module 1020 is able to use the assessment of the geometry from the quasi-3D reconstruction to classify the particle by a type. The type may define the geometry, such as flat, spherical, etc., which is generally indicative of a source of the particle. That is, different sources of contaminants in a factory can produce particles having different shapes. By way of example, welding splatter tends to generate particles that are spherical, while cutting produces particles that are flat.

At 1250, the control module 1020 provides an output identifying the particle. The output may specify the presence of the particle, the source of the particle, the geometry of the particle, and so on. In at least one arrangement, the output causes a downstream device to remove the section of the electrode where the particle is located in order to avoid being integrated with a battery cell that would likely fail because of the presence of the particle. In this way, the scanning system is able to improve the detection of contaminants on electrodes and, thus, reduce battery cell failure rates.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk, C++, Python, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should also be understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A scanning system, comprising:
a camera;
a first light source that emits light at a first wavelength;
a second light source that emits light at a second wavelength that is different from the first wavelength, wherein the first light source and the second light source are arranged to emit the light onto an electrode from different angles, wherein the electrode is moving between separate rolls;
a controller configured to:
control the camera to acquire an image of the electrode, and
analyze the image to detect a foreign metallic particle.

2. The scanning system according to claim 1, wherein the camera is a time delay integration (TDI) camera that captures individual lines of pixels over multiple timesteps of a same area of the electrode.

3. The scanning system according to claim 2, wherein the camera comprises a plurality of pixels arranged in lines that iteratively transfer a charge from a prior line while recapturing the same area of the electrode.

4. The scanning system according to claim 1, wherein the controller is configured to detect the foreign metallic particle with an average diameter greater than or equal to about 25 μm and less than or equal to about 1000 μm.

5. The scanning system according to claim 1, wherein the first light source and the second light source are configured to propagate light onto the electrode that is in a strip and is moving on a roll-to-roll manufacturing line.

6. The scanning system according to claim 5, wherein the first wavelength is in the range of 650 nm to 1000 nm.

7. The scanning system according to claim 5, wherein the second wavelength is in the range of 375 to 475 nm.

8. The scanning system according to claim 1, the first light source and the second light source provide forward-scattered light and backward-scattered light as detected by the camera.

9. The scanning system according to claim 1, wherein the controller is configured to classify a type of the foreign metallic particle according to a quasi-3D reconstruction.

10. The scanning system according to claim 9, wherein the type indicates a source of the foreign metallic particle.

11. The scanning system according to claim 9, wherein the controller is configured to perform the quasi-3D reconstruction by determining a length of a shadow cast by the particle according to the first light source and the second light source and the different angles.

12. A method, comprising:
acquiring an image of an electrode from a time delay integration (TDI) camera, the image being captured by the TDI camera according to a first light source that emits light at a first wavelength and a second light source that emits light at a second wavelength that is different from the first wavelength, wherein the first light source and the second light source are arranged to emit the light onto the electrode from different angles, and wherein the electrode is moving between separate rolls;
analyzing the image to detect a particle that is foreign metal contaminating the electrode; and
providing an output identifying the particle when detected in the image.

13. The method of claim 12, further comprising:
classifying a type of the particle according to a quasi-3D reconstruction.

14. The method of claim 13, wherein the type indicates at least a geometry of the particle that is indicative of a source of the particle.

15. The method of claim 13, wherein classifying the type includes performing the quasi-3D reconstruction by determining a length of a shadow cast by the particle according to the first light source and the second light source and the different angles.

16. The method of claim 12, wherein acquiring the image using the TDI camera includes controlling the TDI camera to capture individual lines of pixels over multiple timesteps of a same area of the electrode.

17. The method of claim 16, wherein controlling the TDI camera includes iteratively transferring a charge from a prior line of an image sensor in the TDI camera while recapturing the same area of the electrode.

18. A non-transitory computer readable medium storing instructions that, when executed by a processor, cause the processor to:
acquire an image of an electrode from a time delay integration (TDI) camera, the image being captured by the TDI camera according to a first light source that emits light at a first wavelength and a second light source that emits light at a second wavelength that is different from the first wavelength, wherein the first light source and the second light source are arranged to emit the light onto the electrode from different angles, and wherein the electrode is moving between separate rolls;
analyze the image to detect a particle that is foreign metal contaminating the electrode; and
provide an output identifying the particle when detected in the image.

19. The non-transitory computer readable medium of claim 18, wherein the instructions to acquire the image using the TDI camera include instructions to control the TDI camera to capture individual lines of pixels over multiple timesteps of a same area of the electrode.

20. The non-transitory computer-readable medium of claim 18, further comprising instructions to:
classify a type of the particle according to a quasi-3D reconstruction by performing the quasi-3D reconstruction by determining a length of a shadow cast by the particle according to the first light source and the second light source and the different angles.
